(19) United States
(12) Patent Application Publication
(10) Pub. No.: US 2009/0138656 A1
(43) Pub. Date: May 28, 2009

(54) Method of skipping synchronization process for initialization of RAID1 device

(75) Inventors: Zhun Liu, Tianjin (CN); Jian-Zhong Wang, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/984,966

(22) Filed: Nov. 26, 2007

(51) Int. Cl. G06F 12/00

(52) U.S. Cl. 711/114; 711/E12.001

(57) ABSTRACT

A method for skipping an initialization process of synchronization of an RAID 1 device skips synchronization process of the RAID1 device through a bitmap technique. First, an RAID1 device is established, a space of the same size is divided from each member disk of the RAID1 device for storing a bitmap corresponding to each data block on each member disk. When a read/write operation is executed on the RAID1 device, before the bit value in the bitmap corresponding to the data block is read, whether the bitmap exists or not is determined first, then corresponding operation is executed according to the bit value in the bitmap corresponding to data block requesting the read/write operation. The method skips synchronization process of the RAID 1 device during the initial establishment, thereby largely saving the time required by the synchronization process for initialization, and further improving the overall performance of the RAID1 device.

### BACKGROUND OF THE INVENTION

1. Field of Invention

The present invention relates to a disk management method, and more particularly to a method of skipping a synchronization process for initialization of an RAID 1 (Redundant Array of Inexpensive Disks) device through a bitmap technique.

2. Related Art

Currently, RAID (Redundant Array of Inexpensive Disks) device is used to combine N hard disks into a virtual single hard disk of a large capacity through an RAID controller (can be hardware or software), so as to provide a larger storage capacity, higher accessing speed or a data redundancy function. According to different data organization methods, the RAID devices are classified into linear mode, RAID-0, RAID-1, RAID-5, RAID-6 and etc. The RAID-1, RAID-5 and RAID-6, and the extending mode of RAID-10 and RAID-50 which derived there-from are all provided a data redundancy function.

The data redundancy function refers to that the RAID device stores redundant data, such that when one or more hard disks in the RAID device are damaged, the complete data still can be obtained from the RAID device by means of a certain method. The RAID device has two methods for storing the redundant data, namely mirror and validation. Mirror method refers to the data of one hard disk in the RAID device is stored in another disk in a mirroring way, such as RAID1.

RAID1 is also referred to as a mirror, which improves the liability through mirror tolerance. That is to say, each working disk has one or more mirror disks, and the data should be also written into the mirror disks while being written into the working disk. Referring to FIG. 1, an original data hard disk 120 of the RAID1 device 100 has a mirror hard disk 140, thus the data of the original data hard disk 120 is copied to the mirror hard disk 140. When reading the data, if something wrong happens on the original data hard disk 120, the data can be read from the mirror hard disk 140. The disk array has a high reliability, but has an effective capacity reduced to lower than a half of the total capacity.

When the RAID1 device is just established, a synchronization process for initializing the original data is required.

However, the way of executing the synchronization process during the establishment of the RAID1 device in the conventional art has the following defects.

1. When the RAID1 device is established initially, the original disk and the mirror disk are inconsistent in the content, it is required to read the data of the original disk and write the data into other RAID1 member disks so as to keep the consistence of the data in respective member disks of the RAID1 device. Therefore, the synchronization process costs a long time, and a great amount of read/write operation required by the synchronization process for initialization may damage the hard disk.

2. Since the RAID1 device is established initially, no external data is written, the read operation on the data not written has not actual meaning.

3. The synchronization process of the RAID1 device takes a long time, and the synchronization process should restart from the initial position of the data region of the RAID1 device after an interruption, which not only wastes time, reduces the overall performance of the system, and also may damage the hard disk.

### SUMMARY OF THE INVENTION

In order to solve the above problems and defects in the conventional art, the present invention is directed to provide a method of omitting a synchronization process for initialization of an RAID1 (Redundant Array of Inexpensive Disks) device, which skips the synchronization process for initialization of the RAID1 device through a bitmap technique.

The method of skipping a synchronization process for initialization of an RAID1 device includes the following steps.

An RAID1 device is established, and a space of the same size is divided from each member disk of the RAID1 device for storing a bitmap corresponding to each data block on each member disk. The storage space of the bitmap on each member disk is initialized, so as to clear the values of the bitmap to zero. The RAID1 device is enabled, and the bitmap is loaded into an inner memory or a buffer memory. When a read operation is executed on the data block of the RAID1 device, a bit value in the bitmap corresponding to the data block is read, when the corresponding bit value in the bitmap is 0, the read operation is executed as the data to be read is 0, and when the corresponding bit value in the bitmap is 1, the read operation is executed according to the read operation process of the RAID1 device. When a write operation is executed on the data block of the RAID 1 device, a bit value in the bitmap corresponding to the data block is read, when the corresponding bit value in the bitmap is 0, the bit value corresponding to the bitmap is updated to be 1, the bitmap information is written into the storage space of the bitmap in the RAID1 device, and after the bitmap is completely updated, the bitmap is unloaded from the inner memory or the buffer memory and the absence of the bitmap is marked in the system, when the corresponding bit value in the bitmap is 1, the write operation is executed according to the write operation process of the RAID1 device.

The method of skipping a synchronization process for initialization of an RAID1 device further includes the following steps.

When a read or write operation is executed on the data block of the RAID1 device, before the bit value in the bitmap corresponding to the data block is read, whether the bitmap exists or not is determined first. If yes, the bit value in the bitmap corresponding to the data block is read; otherwise, the read or write operation is executed according to the read or write operation process of the RAID1 device.

Moreover, each bit of the bitmap is respectively corresponding to each data block of the RAID1 device, and a binary bit 0 in the bitmap is used to indicate that data has not been written in the corresponding data block, and a binary bit 1 is used to indicate that data has been written in the corresponding data block. Furthermore, the capacity of the storage space of the bitmap is calculated through the following formula: capacity of storage space of bitmap÷capacity of data space of the RAID1 device=1÷(number of bytes of data block of the RAID1×8).

Based on the above, the present invention has the following advantages.

The method of skipping a synchronization process for initialization of an RAID1 device provided in the present invention skips the synchronization process for initialization of the RAID1 device during the initial establishment through a bitmap technique, thus the RAID1 device can have a normal performance from the initial establishment while skipping a great amount of read and write operations required for the synchronization process for initialization and saving the time cost by the operations, thereby further improving the overall performance of the RAID1 device and protecting the hard disk in the RAID1 device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a data storage structure of an RAID1 device according to the conventional art;

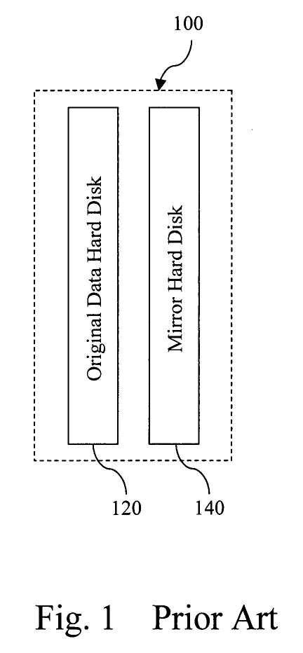

FIG. 2 is a block diagram of a data storage structure of an RAID1 device according to the present invention;

FIG. 3 is a process flow chart of a method of skipping a synchronization process for initialization of an RAID1 device according to the present invention;

FIG. 4 is an exploded flow chart of steps of the method shown in FIG. 3;

FIG. 5 is a diagram of mapping relationship between the bitmap and the data block according to the present invention;

FIG. 6 is a schematic view of initializing a storage space of the bitmap according to the present invention;

FIG. 7 is a schematic view of loading the bitmap into the inner memory or buffer memory according to the present invention;

FIG. 8 is a schematic view of a write operation on the RAID1 device according to the present invention;

FIG. 9 is a schematic view of the states of the bitmap and the data block after a write operation on the RAID1 device according to the present invention;

FIG. 10 is a schematic view of a read operation on the RAID1 device according to the present invention; and

FIG. 11 is a schematic view of unloading the bitmap from the inner memory or buffer memory according to the present invention.

### DETAILED DESCRIPTION OF THE INVENTION

With regard to the features and embodiments of the present invention, detailed illustration on the preferred embodiments is given with reference to the drawings as follows:

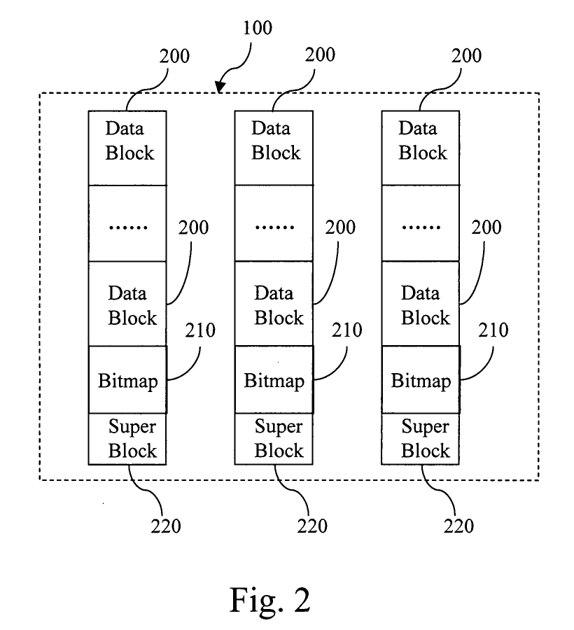

FIG. 2 is a block diagram of a data storage structure of an RAID1 device according to the present invention, in which an RAID1 device 100 is constituted by three hard disks. As shown in FIG. 2, hard disk 1, hard disk 2, and hard disk 3 are respectively constituted by a plurality of data blocks 200, a bitmap 210, and a super block 220. The numbers of bytes in each data block 200 of the RAID1 device 100 is 4 K, and the storage space of the bitmap 210 on each member disk of the RAID1 device is close to the position in front of the super block 220. And, the capacity of the storage space of the bitmap is calculated through the following formula: capacity of the storage space of the bitmap÷capacity of data space of the RAID1 device=1÷(the numbers of bytes of the data block of the RAID1×8) (Formula I). Assuming that the capacity of the data space of the RAID1 device is 1 T (i.e., 1024×1024M), the capacity of each data block is 4 K, and the capacity of the storage space of the bitmap 210 is 1024×1024+(1024×4×8)=32M. Moreover, the process of querying the bitmap is much easier than the conversion of each read/write request in the RAID1, thus the cost in space and time for assigning the bitmap is completely acceptable.

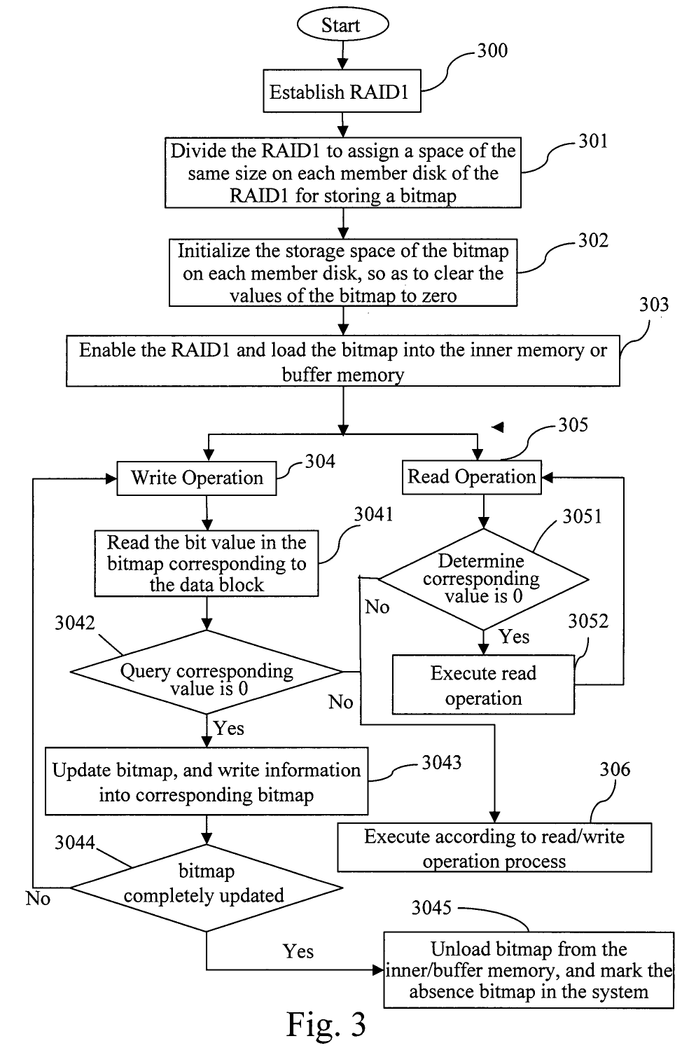

Referring to FIG. 3, a process flow chart of a method of skipping a synchronization process for initialization of an RAID1 device according to the present invention is shown. As shown in FIG. 3, The method of skipping a synchronization process for initialization of an RAID1 device according to the present invention includes the following steps.

An RAID1 device is established (Step 300). A space of the same size is divided from each member disk of the RAID1 device for storing a bitmap corresponding to each data block on each member disk (Step 301). The storage space of the bitmap on each member disk is initialized, so as to clear the values of the bitmap to zero (Step 302). The RAID1 device is enabled, and the bitmap is loaded into an inner memory or a buffer memory (Step 303). When a read operation is executed on the data block of the RAID1 device (Step 304), a bit value in the bitmap corresponding to the data block is read (Step 3041), and whether the corresponding bit value in the bitmap is 0 or not is queried (Step 3042); if no, the process is executed according to the write operation process of the RAID1 device (Step 306), otherwise, the corresponding bit value in the bitmap is updated to be 1, and bitmap information is written into the storage space of the corresponding bitmap of each member disk in the RAID1 device (Step 3043); whether the bitmap is completely updated or not is determined (Step 3044), if no, Step 304 continues, otherwise, the bitmap is unloaded from the inner memory or the buffer memory and the absence of the bitmap is marked in the system (Step 3045). When a read operation is executed on the data block of the RAID1 device (Step 305), whether the corresponding bit value in the bitmap is 0 or not is determined (Step 3051); if yes, the read operation is executed as the data to be read is 0 (Step 3052), and then Step 305 continues; otherwise, the process is executed according to the read operation process of the RAID1 device (Step 306).

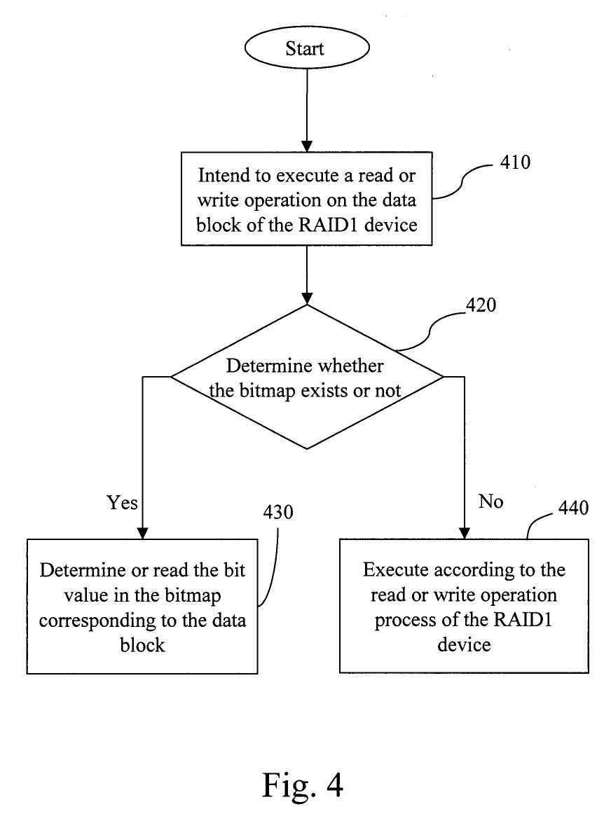

FIG. 4 is an exploded flow chart of steps of the method shown in FIG. 3. As shown in FIG. 4, The method of skipping a synchronization process for initialization of an RAID1 device further includes the following steps.

When a read or write operation is executed on the data block of the RAID1 (Step 410), before the bit value in the bitmap corresponding to the data block is determined or read, whether the bitmap exists or not is determined first (Step 420), if yes, the bit value in the bitmap corresponding to the data block is determined or read continuously (Step 430), otherwise, the read or write operation is executed according to the read or write operation process of the RAID1 device (Step 440).

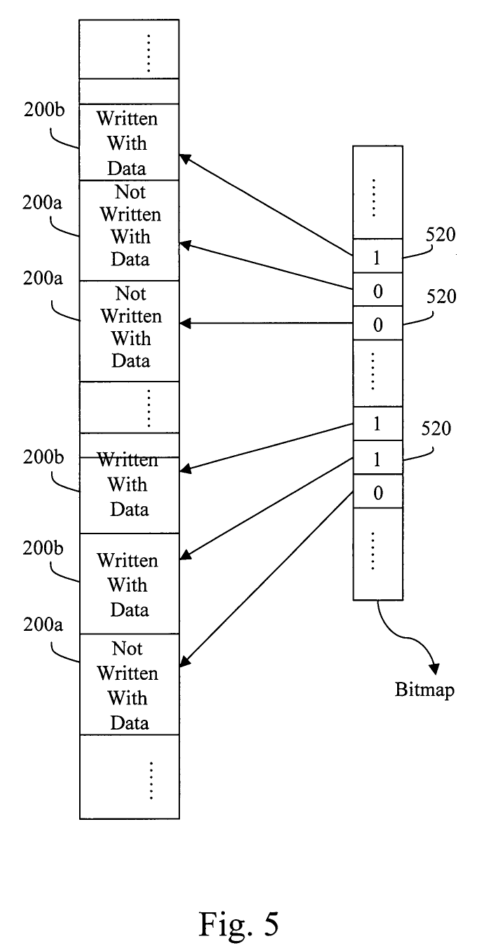

FIG. 5 is a diagram of mapping relationship between the bitmap and the data block according to the present invention. As shown in FIG. 5, the value of each bit 520 in the bitmap corresponding to each data block is indicated by a binary number 1 or 0. When the value of the bit 520 of the bitmap is 1, it indicates that data has been written in the corresponding data block 200b before the read/write operation, and when the value of the bit 520 of the bitmap is 0, it indicates that data has never been written in the corresponding data block 200a before.

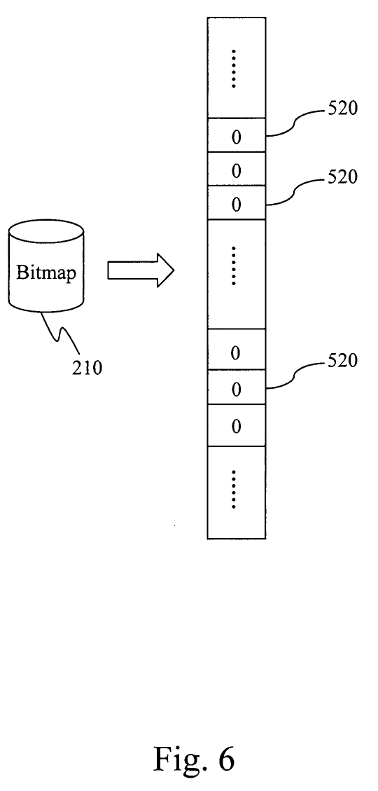

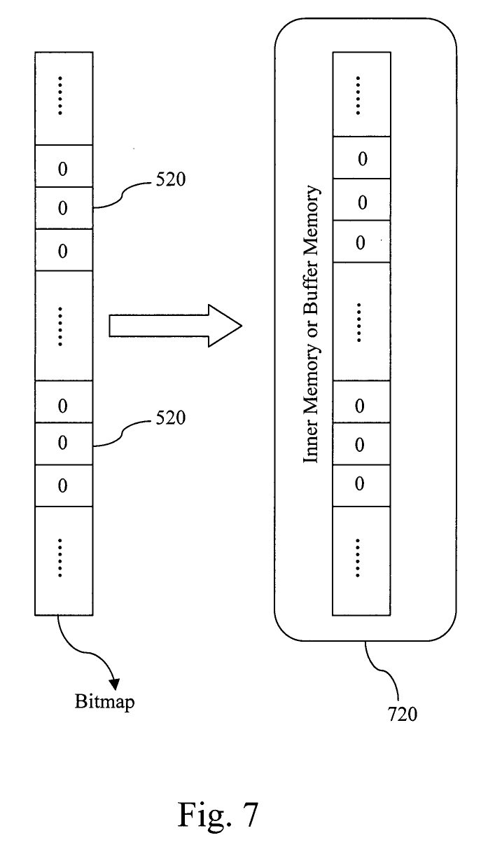

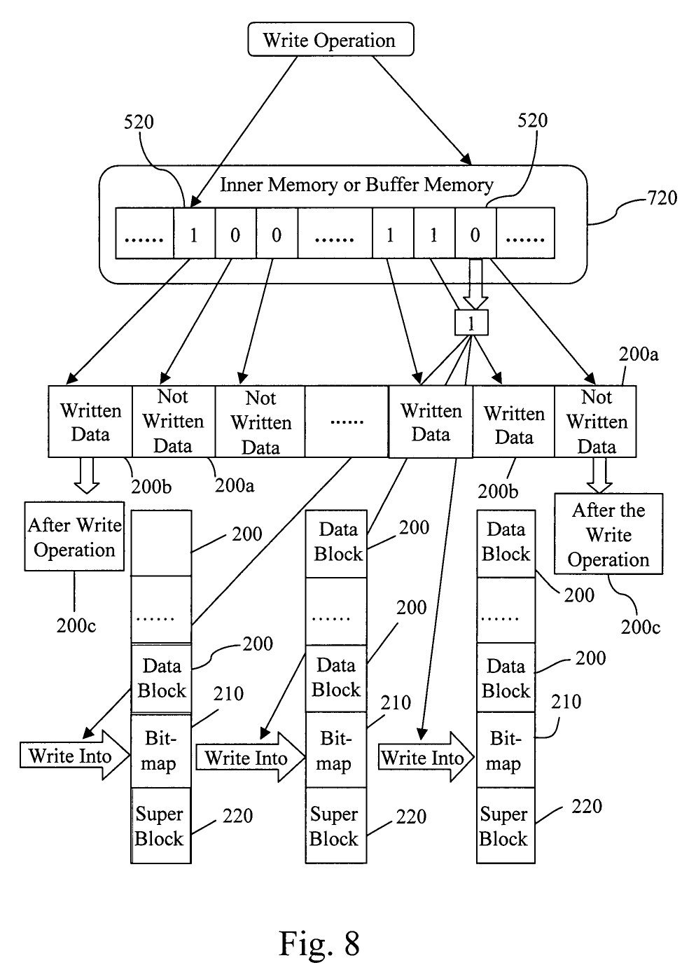

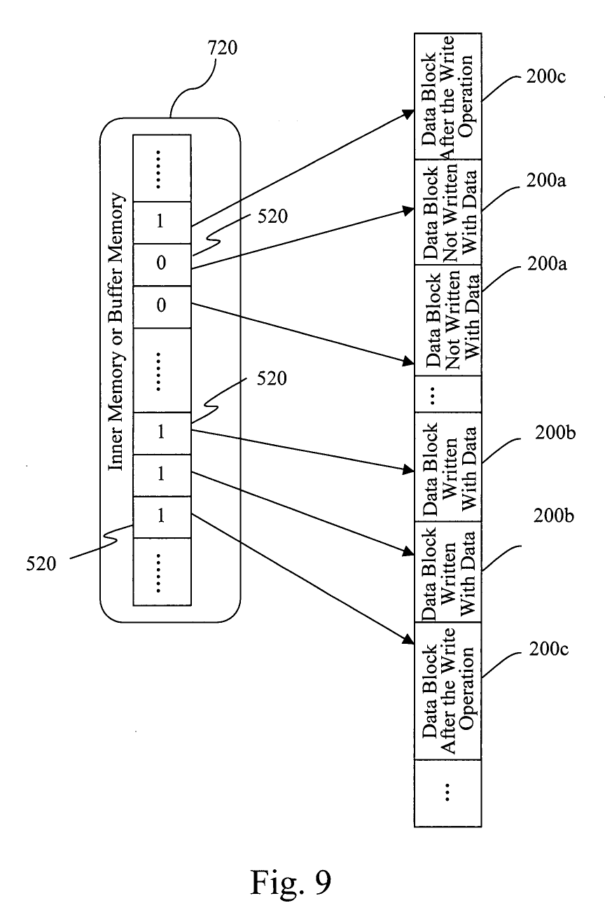

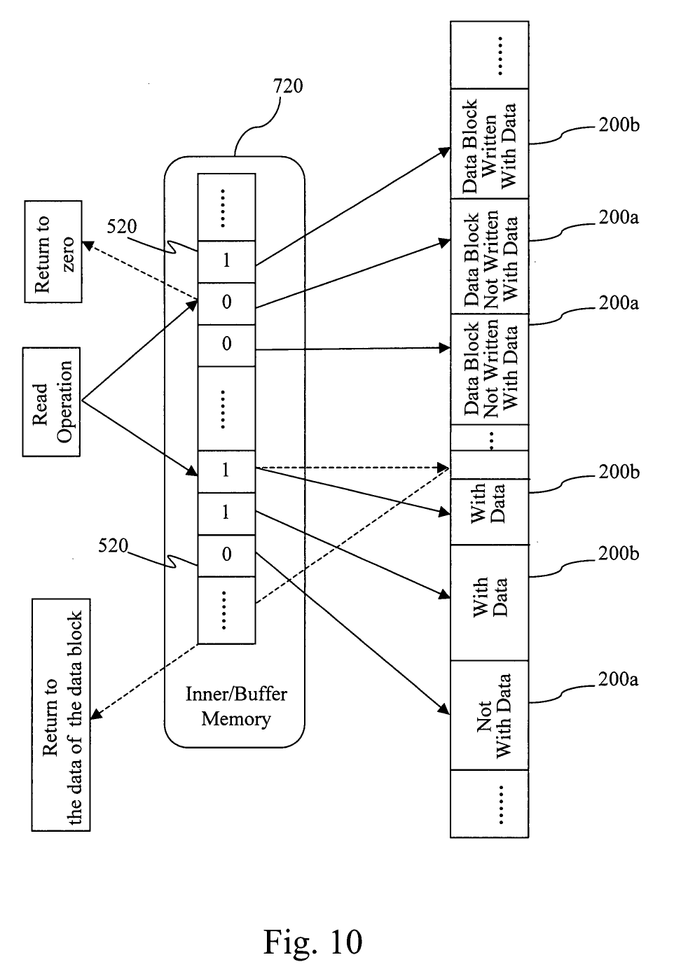

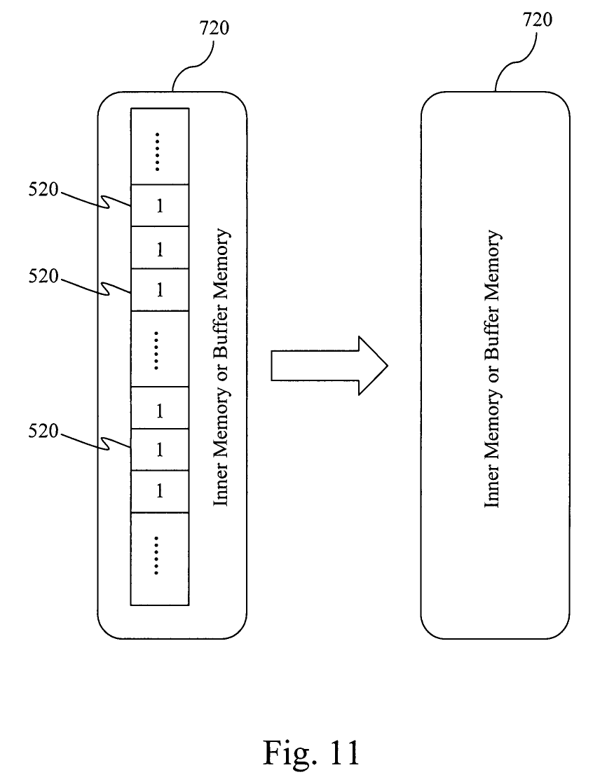

Now The method of skipping a synchronization process for initialization of an RAID1 device of the present invention is illustrated in detail with reference to the mapping relationship between the bitmap and the data block of the present invention and the data storage structure of the RAID1 device of the present invention. FIG. 6 is a schematic view of initializing a storage space of the bitmap according to the present invention. As shown in FIG. 6, when the RAID1 device is established initially, and after a space of the same size is divided from each member disk of the RAID1 device for storing the bitmap corresponding to each data block on each member disk, the space for storing the bitmap 210 on each member disk is initialized, such that all the values of the bit 520 of the bitmap are 0. FIG. 7 is a schematic view of loading the bitmap into the inner memory or buffer memory according to the present invention. As shown in FIG. 7, after all the values of the bit 520 of the bitmap are cleared to zero, the bitmap is loaded into the inner memory or the buffer memory 720. FIG. 8 is a schematic view of a write operation on the RAID1 device according to the present invention. As shown in FIG. 8, when a write operation is executed on the data block of the RAID1 device, corresponding operations are executed according to the value of the bit 520 of the bitmap in the inner memory or buffer memory 720 (referring to the Step 304, Step 3041, and Step 3042 of the above method). If the bit value of the bitmap in the inner memory or buffer memory 720 corresponding to the data block to be written is 1, it indicates that the data block is a data block 200b written with data before the write operation, then the write operation is executed according to the original write operation process of the RAID1 (referring to the above Step 306), after that, the data block 200b written with data before is turned into a data block 200c after the write operation. If the bit value of the corresponding bitmap is 0, the data block is a data block 200a never written with data before, thus the bit value corresponding to the bitmap is updated to be 1, then the bitmap information is written into the storage space of the bitmap in the RAID1 device (referring to the above Step 3043), thereby the data block 200a never written with data before is also turned into a data block 200c after the write operation. FIG. 9 is a schematic view of the states of the bitmap and the data block after a write operation on the RAID1 device according to the present invention. As shown in FIG. 9, after the write operation on the RAID1 device is finished, the value 1 of the bit 520 of the bitmap in the inner memory or buffer memory 720 is corresponding to the data block 200c after the write operation and the data block 200b written before the write operation in the data blocks respectively, and the value 0 of the bit 520 of the bitmap is corresponding to the data block 200a never written before. FIG. 10 is a schematic view of a read operation on the RAID1 device according to the present invention. As shown in FIG. 10, when the read operation is executed, whether the value of the corresponding bit 520 in the bitmap is 0 or not is queried and determined first (referring to the Step 305 and Step 3051 in the above method). If the value is 0, the data block corresponding to the bit of the bitmap is proved to be the data block 200a never written before the read operation, thus the read operation is executed as the data to be read is 0 (referring to the above Step 3052), that is the process of “returning to zero” as shown in FIG. 10. If the value is 1, the data block corresponding to the bit of the bitmap is proved to be the data block 200b written before the read operation, thus the read operation is executed according to the original read operation process of the RAID1 device (referring to the above Step 306), that is the process of “returning to the data of the data block” as shown in FIG. 10. FIG. 11 is a schematic view of unloading the bitmap from the inner memory or buffer memory according to the present invention. As shown in FIG. 11, after the bitmap is completely updated, the values of the bit 520 in the bitmap corresponding to each data block are all 1, thus the bitmap is unloaded from the inner memory or buffer memory 720, and the absence of the bitmap is marked in the system (referring to the above Step 3045).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of skipping a synchronization process for initialization of an RAID 1 (Redundant Array of Inexpensive Disks) device, for skipping the synchronization process for initialization of the RAID1 device through a bitmap technique, the method comprising:
establishing an RAID1 device, and dividing a space of the same size from each of a plurality of member disks of the RAID1 device for storing a bitmap corresponding to each of the plurality of data blocks on each member disk;
initializing a storage space of the bitmap on each member disk, so as to clear the values of the bitmap to zero;
enabling the RAID1 device, and loading the bitmap into an inner memory or a buffer memory;
when a read operation is executed on the data block of the RAID1 device, reading a bit value in the bitmap corresponding to the data block, wherein when the corresponding bit value in the bitmap is 0, the read operation is executed as the data to be read is 0, and when the corresponding bit value in the bitmap is 1, the read operation is executed according to the read operation process of the RAID1 device; and
when a write operation is executed on the data block of the RAID1 device, reading a bit value in the bitmap corresponding to the data block, wherein when the corresponding bit value in the bitmap is 0, the bit value corresponding to the bitmap is updated to be 1, bitmap information is written into the storage space of the bitmap in the RAID1 device, and after the bitmap is completely updated, the bitmap is unloaded from the inner memory or the buffer memory and the absence of the bitmap is marked in the system, and when the corresponding bit value in the bitmap is 1, the write operation is executed according to the write operation process of the RAID1 device.

2. The method of skipping a synchronization process for initialization of an RAID1 device as claimed in claim 1, further comprising:
when a read or write operation is executed on the data block of the RAID1, before reading the bit value in the bitmap corresponding to the data block, first determining whether the bitmap exists or not, if yes, reading the bit value in the bitmap corresponding to the data block, otherwise, executing the read or write operation according to the read or write operation process of the RAID1 device.

3. The method of skipping a synchronization process for initialization of an RAID1 device as claimed in claim 1, wherein each bit of the bitmap is respectively corresponding to each data block of the RAID1 device, and a binary bit 0 in the bitmap is used to indicate that data has not been written in the data block, and a binary bit 1 is used to indicate that data has been written in the data block.

4. The method of skipping a synchronization process for initialization of an RAID1 device as claimed in claim 1, wherein the capacity of the storage space of the bitmap is calculated through the following formula:
capacity of the storage space of the bitmap capacity of data space of the RAID1 device=1÷(number of bytes of the data block of the RAID1×8).

5. The method of skipping a synchronization process for initialization of an RAID1 device as claimed in claim 4, wherein the number of the bytes of each data block of the RAID1 device is 4 K.

6. The method of skipping a synchronization process for initialization of an RAID1 device as claimed in claim 1, wherein the storage space of the bitmap on each member disk of the RAID1 device is close to a position in front of a super block.
